(19) United States
(12) Patent Application Publication
(10) Pub. No.: US 2011/0308868 A1
(43) Pub. Date: Dec. 22, 2011

(54) System for driving an animal powered vehicle

(75) Inventor: Udayasankar Devanaboyina, Fremont, CA (US)

(73) Assignee: Mr. Udayasankar Devanaboyina, Fremont, CA (US)

(21) Appl. No.: 13/159,434

(22) Filed: Jun. 14, 2011

Related U.S. Application Data
(60) Provisional application No. 61/354,441, filed on Jun. 14, 2010.

(51) Int. Cl. B62M 6/00; B62M 1/00; B62M 6/40; B62M 1/02

(52) U.S. Cl. 180/65.31; 280/231

(57) ABSTRACT

A system for conversion of an animal muscle power to a mechanical or electrical energy, for use in transportation of people, goods and for other purposes is disclosed. The system for conversion of an animal muscle power to a mechanical or electrical energy includes a chassis to accommodate at least one of an animal at a predetermined position, at least one first crank. set and pedals to accommodate the front legs, at least one second crank set to accommodate the hind legs for enabling the conversion of the animal muscle power to driving power, at least one weight-bearing provision to bear the weight of most of the animal and to minimize weight of the animal on its feet, thereby, avoiding the animal lifting itself up against gravity while pedaling when not required, at least one transmission element positioned between the crank set and a drive train to integrate the crank set to the drive train for transferring the rotational energy of the crank set to the axle with a gear mechanism, causing the animal powered vehicle to move when the animal exerts force on the pedals.

### TECHNICAL FIELD OF THE INVENTION

The present invention generally relates to a system for conversion of the animal muscle power to a mechanical or an electrical energy that can be used for transportation of people, goods or for other purposes.

### BACKGROUND

Prior to the advent of motor vehicles, animals and animal powered vehicles (APVs) are the primary mode of transportation of goods and people, which included horses, mules, camels, bullock carts, horse carriages, and the like. Draft animal power is being used extensively even till to date in agricultural operations worldwide. Despite the advent of fuel-powered motor vehicles, the APVs are being used to carry significant amount of loads worldwide, especially in the developing world. Over the years, several design modifications were made to the conventional APVs which resulted in significant improvement in the load carrying capacity of the APVs. These design modifications, however, did not result in any significant improvements in the average speed of the APVs. The speed at which an APV travels, for the most part, is dictated by the walking or running speed of the animal that is pulling the vehicle. As a result, with the advent of steam or fuel-powered vehicles, the use of APVs had decreased considerably.

The fuel or other alternate power driven motor vehicles play a conspicuous role in the modern industrial economy and for convenient mobility. However, the fuel-driven vehicles are a major source of pollution and also contribute to global warming, accounting for a large and growing share of greenhouse gas emissions worldwide, with implications for a wide variety of human health and environmental problems, and suggest an urgent need for alternative modes of transportation.

The conventional use of animals either for riding or transporting goods with APVs (e.g., bullock carts) typically involves animals carrying significant loads, often subjecting them to excessive physiological stress, sometimes injuries, leading to less productivity and lower cost-efficiency. Therefore, it is important to modify the existing APV designs to make them more humane and gentle to animals, which in turn will lead to improvements in their overall efficiency.

Additionally, due to a decrease in the overall use of the draft animal power in the recent times, the number of animals and breeds that have been traditionally used for draft purposes have started declining. If such trend continues, there is a real danger that such breeds could become extinct. Therefore, a need exists to urgently improve the current design of APVs, to make them compete with the motor vehicles so that the overall draft animal usage in agriculture and other operations can be improved.

A novel system and a method to improve the efficiency of APVs are described in the current application. The proposed design changes to the current APVs are expected to be more gentle and humane to the animals, increase the speed and load carrying capacity, and improve the range of distance covered, thereby positively contributing to the economy without adversely affecting environment and the ecosystem.

### SUMMARY

A system and a method for conversion of an animal muscle power to a mechanical or electrical energy are disclosed. According to a non limiting exemplary a first aspect of the present invention, a system for conversion of animal muscle power to electrical or mechanical energy includes a animal cart which includes a chassis to accommodate at least one of an animal at a predetermined position, at least one first crank set to accommodate the front legs, at least one second crank set to accommodate the hind legs, at least one third crank set is provided for the rider and at least one axle for enabling the conversion of the animal muscle power to driving force. The crank set may comprise a pedal, a sprocket, a pulley, a chain, a driving belt or similar mechanisms to convert the natural movement of the feet to mechanical or electrical energy.

According to a non limiting exemplary the first aspect of the present invention, the system for conversion of an animal muscle power to an electrical or mechanical energy includes at least one set of pedals and at least one crank set to accommodate the front legs, and/or at least one set of pedals to accommodate the hind legs of at least one animal. The animal cart is accommodated with the at least one of the animal, which operates the vehicle by placing at least one foot in or on the pedals of the animals cart. The animal operates by pressing the pedals in the forward or backward direction, which is converted to either mechanical or electrical energy. The conversion of muscle power to electrical energy is achieved by an energy conversion device associated with the pedals and crank set or the like. The electrical energy generated is used either directly or stored in a storage device (e.g. like a rechargeable battery) and used to drive the animal powered vehicle using an electric motor located on the axel of the wheel(s).

According to a non limiting exemplary the first aspect of the present invention, the system for conversion of an animal muscle power to an electrical or mechanical energy includes, the pedals of the crank set positioned to accommodate the front legs and/or rear legs of the animal can be pedaled in either of a clock wise direction or an anti clock wise direction according to the anatomy of the front or rear legs of the animal. Alternatively, the animal cart can be provided with a tread mill type of mechanism, instead of the pedaling system to convert muscle power to a mechanical or electrical energy. The tread mill type system comprises of rollers and a moving sheet of belt of other provisions, and allows the animal to walk naturally on the rolling sheet, while remaining stable at in one place. The walking movement of the animal results in rotational movement of the rollers, which in turn is used to drive the animal cart.

According to a non limiting exemplary the first aspect of the present invention, the system for conversion of an animal muscle power to an electrical or mechanical energy includes at least one transmission element can be positioned between the crank set and a drive train to integrate the crank set to the drive train for transferring the energy of the crank set to the drive train and or the wheels. A drive train extending between a plurality of wheels and the at least one of the transmission element facilitates the transmitting of the driving force to the axle with associated gear mechanism, causing the animal cart to move.

According to a non limiting exemplary the first aspect of the present invention, the system for conversion of an animal muscle power to an electrical or mechanical energy includes at least one additional crank set for at least one rider (or driver) of the animal cart at a predetermined position to convert human pedaling power to driving power. The driving force from the at least such one additional crank set provided to the rider is integrated by the transmission element into the drive train in a similar fashion, as described earlier in previous paragraph.

According to a non limiting exemplary the first aspect of the present invention, the system for conversion of an animal muscle power to an electrical or mechanical energy includes the animal cart provided with a steering mechanism, braking system, that may including additional features such as the ability to capture breaking energy when stopped (regenerative breaking energy type), manual or an automated gear mechanism, accelerator, clutch, suspension systems and shock absorbers to cushion the ride, differential systems to improve stability, power supply, lights, signals, horn, fans, air conditioning, auxiliary power sources, hitches for trailers or auxiliary equipment, devices to connect and power the auxiliary equipment, and the like. The front, sides, back, and top of the animal cart are covered appropriately to provide protection to the animal and rider from the sun, wind, snow and the rain or other weather conditions, and road hazards, and for improved visibility.

According to a non limiting exemplary the first aspect of the present invention, the system for conversion of an animal muscle power to an electrical or mechanical energy includes the plurality of pedals provided for the animal are accommodated with an anti-slippery top surface, and provisions to securely hold at least one of an animal hoof or foot to the plurality of pedals, thereby allowing for free movement of the feet, while pedaling. The shape of the pedals can be flat, cup shaped, tubular, a long grove and provided with straps, belts, bolts, clip on mechanism or provided with magnets or similar devices to facilitate the animal to engage and disengage the pedals with its hooves easily, while allowing for free movement of the legs. Further, the shape, size and position of the crank sets and pedals on the chassis and the weight bearing mechanism (described below), holding devices, distance between the wheels, chassis shape and strength, and other devices on the animal cart can be changed or adjusted to accommodate different type, size, shape and weight animals so as to maintain the functionality of the animal cart.

According to a non limiting exemplary the first aspect of the present invention, the system for conversion of an animal muscle power to an electrical or mechanical energy includes at least one of a weight bearing provision located on the animal cart at a predetermined position to partially or completely bear the weight of the animal. The weight bearing provision can be positioned to come into contact with ventral, lateral, dorsal, posterior or anterior aspects of the body at any location, including head, neck, legs, shoulder, sternum, chest, abdomen, pelvic, rump, thigh, and hip regions of the body so as to bear most of the weight of the upper body of the animal (the part of the animal excluding limbs), thereby, minimizing the weight on the feet. The weight bearing provision functions very similar to a standard bicycle seat, which supports the majority of the weight of the upper body of the human rider, excluding the feet. The weight bearing provision can be a suspension type (e.g., similar to hammock) or a standard seat type positioned appropriately to bear the weight of the animal. The height of the weight bearing provision relative to the pedals or the like devices is adjusted such that the significant portion of the weight of the animal including head, neck and torso or the trunk portion of the animal are shifted to the weight bearing provision from its feet, when positioned on the animal cart. The weight bearing mechanism thereby allows the animal to use its leg muscles to rotate the pedals, without lifting itself against the gravity when pedaling, there by maximizing the efficiency with which the muscle power is converted to mechanical or electrical energy for sustained driving of the animal cart, without undue physiological stress. The animal cart is provided with mechanisms to adjust the height of the device, so that weight of the animal can be completely switched to its feet, and in turn on to pedals when necessary, so that animal can use its weight to aid in pedaling, when higher input is required over short periods. The weight bearing mechanism could be a plurality of devices, and can be supported from bottom, on the sides, top or in the front and back. The weight bearing provision can be anchored to the chassis, suspended from top, supported from bottom or sides or attached to any other part of the animal cart, and its weight can be raised or lowered and its position relative to other parts of the vehicle are adjusted using either a suspension type of system or using manual or automated adjustment systems (e.g. a hydraulic telescoping type). The shape and size of the weight bearing provision can be modified to fit individual animals of different species, size, shape, weight, anatomical structures or the like., The additional devices made of or lined with appropriate material to support the animal while pedaling, while quick release of animal and at emergency situations.

According to a non limiting exemplary the first aspect of the present invention, the system for conversion of an animal muscle power to an electrical or mechanical energy includes the animal cart provided with a movable ramp used by the animals to climb onto a raised platform where the pedals and the weight bearing mechanism are arranged. Alternatively, an optional, lifting mechanism is provided to lift the animal to a predetermined height and to securely position in the weight bearing provision. The mechanism is adjusted either manually, or powered by either the animal, human or by other alternative means (e.g., an electric battery or fuel-powered auxiliary mechanism on board). To minimize impact to the weight bearing portions of the animals when secured to the weight bearing provision, the weight bearing mechanism is secured using plurality of suspension systems, springs, control arms, shock absorbers, mechanical dampers and the like.

According to a non limiting exemplary the first aspect of the present invention, the system for conversion of an animal muscle power to an electrical or mechanical energy includes at least one collar, at least one harness, and at least one restraint is provided for securing at least one animal positioned over the weight bearing provision. The animal cart comprises of other mechanisms secured to the head or various parts of the body to facilitate communication of driver/rider's intention to the animal so as to make the animal perform certain actions. The animal cart further comprises of an additional safety mechanisms like air bags are provided to protect the animals in a collision and quick-release mechanism in emergency situations. The animal cart will be equipped with appropriate sensors and mechanisms that sense the potential changes in the balance of the animal cart due to movement of the animal and those than can institute the appropriate corrective mechanisms to maintain the balance. Further, the animal cart is provided with appropriate sensors and mechanisms to measure and display certain parameters such as body temperature, heart rate, respiratory rate and the like to monitor the physiological status of the animal.

According to a non limiting exemplary the first aspect of the present invention, the system for conversion of an animal muscle power to an animal muscle power to an electrical or mechanical energy includes the provisions to provide food, water and other required. Additionally, the animal cart is equipped with additional mechanisms positioned appropriately at external orifices to collect external discharges such as urine and feces from the animal for secure storage and disposal. Further, appropriate mechanisms such as covers, shields, etc are provided to protect the various parts of the animal cart and the rider/driver from the animal discharges. The animal cart includes at least one provision to release the securely held feet of the animal from the plurality of pedals, as well as to release the animal from the weight bearing mechanism and the restraints.

According to a non limiting exemplary a second aspect of the present invention, a system for conversion of an animal muscle power to an electrical or mechanical energy comprises a wheeled animal powered vehicle includes a chassis to accommodate at least one of an animal at a predetermined position, at least one first crank set to accommodate the front legs, at least one second crank set to accommodate the hind legs, at least one additional crank set is provided for the rider and at least one axle for enabling the conversion of the animal muscle power to driving force. The crank set may comprise a pedal, a sprocket, a pulley, a chain, a driving belt or similar mechanisms to convert the natural movement of the feet to mechanical or electrical energy.

According to a non limiting exemplary the second aspect of the present invention, the system for conversion of an animal muscle power to an electrical or mechanical energy includes at least one set of pedals and at least one crank set to accommodate the front legs, and/or at least one set of pedals to accommodate the hind legs of at least one animal. The wheeled animal powered vehicle is accommodated with the at least one of the animal, which operates the vehicle by placing at least one foot in or on the pedals. The animal operates by pressing the pedals in the forward or backward direction, which is converted to either mechanical or electrical energy. The conversion of muscle power to electrical energy is achieved by an energy conversion device associated with the pedals and crank set or the like. The electrical energy generated is used either directly or stored in a storage device (e.g. like a rechargeable battery) and used to drive the animal powered vehicle using an electric motor located on the axel of the wheel(s).

According to a non limiting exemplary the second aspect of the present invention, the system for conversion of an animal muscle power to an electrical or mechanical energy includes the pedals of the crank set positioned to accommodate the front legs and/rear legs of the animal can be pedaled in either of a clock wise direction or an anti clock wise direction according to the anatomy of the front or rear legs of the animal. Alternatively, the wheeled animal powered vehicle can be provided with a tread mill type of mechanism, instead of the pedaling system to convert muscle power to a mechanical or electrical energy. The tread mill type system comprises of rollers and a moving sheet of belt of other provisions, and allows the animal to walk naturally on the rolling sheet, while remaining stable at in one place. The walking movement of the animal results in rotational movement of the rollers, which in turn is used to drive the animal cart.

According to a non limiting exemplary the second aspect of the present invention, the system for conversion of an animal muscle power to an electrical or mechanical energy comprises at least one transmission element can be positioned between the crank set and a drive train to integrate the crank set to the drive train for transferring the rotational energy of the crank set to the drive train and or the wheels. A drive train extending between a plurality of wheels and the at least one of the transmission element facilitates the transmitting of the driving force to the axle with associated gear mechanism, causing the wheeled animal powered vehicle to move.

According to a non limiting exemplary the second aspect of the present invention, the system for conversion of an animal muscle power to an electrical or mechanical energy includes at least one additional crank set is provided for the rider (or driver) of the wheeled animal powered vehicle at a predetermined position to convert human pedaling power to driving power. The driving force from the at least one additional crank set provided to the rider is integrated by the transmission element into the drive train in a similar fashion, as described earlier in previous paragraph.

According to a non limiting exemplary the second aspect of the present invention, the system for conversion of an animal muscle power to an electrical or mechanical energy includes an electrical energy generator is provided along with the crank sets that may be associated with the pedals, the crank, the pulley or the within the crank set provided for each animal and the rider to convert the peddling power of both the rider and/or the animal in to an electrical energy and which is further stored in at least one of a rechargeable battery unit. An electrical power output socket with a phase shifting/converter mechanism is provided to convert the electrical energy generated from the at least one of the electrical generator at a pre determined efficiency ratio and is further transferred through a cable and stored in at least one of the rechargeable batteries.

According to a non limiting exemplary the second aspect of the present invention, the system for conversion of an animal muscle power to an electrical or mechanical energy includes an at least one auxiliary power generation unit such as fuel engine, electric engine, a hybrid engine and the like to improve the speed of the vehicle by utilizing the electrical energy stored in the rechargeable batteries to move along or to make a at least one of a wheeled vehicle coupled at a pre determined position to the animal powered vehicle to move or make them work. The at least one of the wheeled vehicle coupled to the animal powered vehicle could be a trolley or the like that could be used to transport goods or the like and/or to cultivate or the like.

According to a non limiting exemplary the second aspect of the present invention, the system for conversion of an animal muscle power to an electrical or mechanical energy comprises the wheeled animal powered vehicle provided with a steering mechanism, braking system, that may including additional features such as the ability to capture breaking energy when stopped (regenerative breaking energy type), manual or an automated gear mechanism, accelerator, clutch, suspension systems and shock absorbers to cushion the ride, differential systems to improve stability, power supply, lights, signals, horn, fans, air conditioning, auxiliary power sources, hitches for trailers or auxiliary equipment, devices to connect and power the auxiliary equipment, and the like. The front, sides, back, and top of the animal cart are covered appropriately to provide protection to the animal and rider from the sun, wind, snow and the rain or other weather conditions, and road hazards, and for improved visibility.

According to a non limiting exemplary the second aspect of the present invention, the system for conversion of an animal muscle power to an electrical or mechanical energy includes the plurality of pedals provided for the animal are accommodated with an anti-slippery top surface, provisions to securely hold at least one of an animal hoof or foot to the plurality of pedals, thereby allowing for free movement of the feet, while pedaling. The shape of the pedals can be flat, cup shaped, tubular, a long grove and provided with straps, belts, bolts, clip on mechanism or provided with magnets or similar devices to facilitate the animal to engage and disengage the pedals with its hooves easily, while allowing for free movement of the legs. Further, the shape, size and position of the crank sets and pedals and the like, on the chassis and weight bearing mechanism, holding devices, distance between the wheels, chassis shape and strength, and other devices on the wheeled animal powered vehicle can be changed or adjusted to accommodate different type, size, shape and weight animals so as to maintain the functionality of the wheeled animal powered vehicle.

According to a non limiting exemplary the second aspect of the present invention, the system for conversion of an animal muscle power to an electrical or mechanical energy includes at least one of a weight bearing provision at a predetermined position to partially or completely bear the weight of the animal. The weight bearing provision can be positioned to come into contact with ventral, lateral, dorsal, posterior or anterior aspects of the body at any location, including head, neck, legs, shoulder, sternum, chest, abdomen, pelvic, rump, thigh, and hip regions of the body so as to bear most of the weight of the upper body of the animal (the part of the animal excluding limbs), thereby, minimizing the weight on the feet. The weight bearing provision functions very similar to a standard bicycle seat, which supports the majority of the weight of the upper body of the human rider, excluding the feet. The weight bearing provision can be a suspension type (e.g., similar to hammock) or a standard seat type positioned appropriately to bear the weight of the animal. The height of the weight bearing provision relative to the pedals or the like devices is adjusted such that the significant portion of the weight of the animal including head, neck and torso or the trunk portion of the animal are shifted to the weight bearing provision from its feet, when positioned on the animal cart. The weight bearing mechanism thereby allows the animal to use its leg muscles to rotate the pedals, without lifting itself against the gravity when pedaling, there by maximizing the efficiency with which the muscle power is converted to mechanical or electrical energy for sustained driving of the wheeled animal powered vehicle, without undue physiological stress. The animal powered wheeled vehicle is provided with mechanisms to adjust the height of the device, so that weight of the animal can be completely switched to its feet, and in turn on to pedals when necessary, so that animal can use its weight to aid in pedaling, when higher input is required over short periods. The weight bearing mechanism could be a plurality of devices, and can be supported from bottom, on the sides, top or in the front and back. The weight bearing provision can be anchored to the chassis, suspended from top, supported from bottom or sides or attached to any other part of the vehicle, and its weight can be raised or lowered and its position relative to other parts of the vehicle are adjusted using either a suspension type of system or using manual or automated adjustment systems (e.g. a hydraulic telescoping type). The shape and size of the weight bearing provision can be modified to fit individual animals of different species, size, shape, weight, anatomical structures or the like. The additional devices made of or lined with appropriate material to support the animal while pedaling, while quick release of animal and at emergency situations.

According to a non limiting exemplary second aspect of the present invention, the system for conversion of an animal muscle power to an electrical or mechanical energy includes the wheeled animal powered vehicle provided with a movable ramp used by the animals to climb onto a raised platform where the pedals and the weight bearing mechanism are arranged. Alternatively, an optional, lifting mechanism is provided to lift the animal to a predetermined height and to securely position in the weight bearing provision. The mechanism is adjusted either manually, or powered by the either animal, human or by other alternative means (e.g., an electric battery or fuel-powered auxiliary mechanism on board). To minimize impact to the weight bearing portions of the animals when secured to the weight bearing provision, the weight bearing mechanism is secured using plurality of suspension systems, springs, control arms, shock absorbers, mechanical dampers and the like.

According to a non limiting exemplary second aspect of the present invention, the system for conversion of an animal muscle power to an electrical or mechanical energy includes at least one collar, at least one harness, and at least one restraint is provided for securing at least one animal positioned over the weight bearing provision. The wheeled animal powered vehicle comprises of other mechanisms secured to the head or various parts of the body to facilitate communication of driver/rider's intention to the animal so as to make the animal perform certain actions. The wheeled animal powered vehicle further comprises of an additional safety mechanisms like air bags are provided to protect the animals in a collision and quick-release mechanism in emergency situations. The wheeled animal powered vehicle will be equipped with appropriate sensors and mechanisms that sense the potential changes in the balance of the wheeled animal powered vehicle due to movement of the animal and those than can institute the appropriate corrective mechanisms to maintain the balance. Further, the wheeled animal powered vehicle is provided with appropriate sensors and mechanisms to measure and display certain parameters such as body temperature, heart rate, respiratory rate and the like to monitor the physiological status of the animal.

According to a non limiting exemplary the second aspect of the present invention, the system for conversion of an animal muscle power to an electrical or mechanical energy includes the provisions to provide food, water and other required. Additionally, the wheeled animal powered vehicle is equipped with additional mechanisms positioned appropriately at external orifices to collect external discharges such as urine and feces from the animal for secure storage and disposal. Further, appropriate mechanisms such as covers, shields, etc are provided to protect the various parts of the animal cart and the rider/driver from the animal discharges. The wheeled animal powered vehicle includes at least one provision to release the securely held feet of the animal from the plurality of pedals, as well as to release the animal from the weight bearing mechanism and the restraints.

According to a non-limiting exemplary a third aspect of the present invention, the system for conversion of an animal muscle power to an electrical or mechanical energy includes an animal cycle with at least two wheels, a front and a rear wheel (e.g., like a bicycle). Additional wheels may be provided to maintain the balance of the animal cycle. The chassis or the frame of the animal cycle is provided with at least one crank set to convert the animal muscle power to mechanical or electrical energy, and provisions for steering (e g handle), breaking, gear shifting, lighting mechanisms.

According to a non limiting exemplary the third aspect of the present invention, the system for conversion of an animal muscle power to an electrical or mechanical energy includes a chassis to accommodate at least one of an animal at a predetermined position, at least one first crank set to accommodate the front legs, at least one second crank set to accommodate the hind legs, at least one third crank set is provided for the rider and at least one axle for enabling the conversion of the animal muscle power to driving power. The crank set may comprise a pedal, a sprocket, a pulley a chain a driving belt and the like. Additionally, the animal cycle comprises of a weight bearing provision to bear the weight of most of the animal in order to minimize its weight on the feet, there by facilitating the pedaling, without the animal lifting itself against gravity, to maximize the efficiency.

According to a non limiting exemplary the third aspect of the present invention, the system for conversion of an animal muscle power to an electrical or mechanical energy includes the animal cycle provided with at least one gyroscopic mechanism to maintain the balance of the vehicle when at rest or while in motion. The rider is provisioned to be seated on the top of the animal, or alternatively on a seat attached to the chassis or other parts, and positioned either above on the sides, back or in front of the animal. The animal cycle is provided with at least one optional crank set to pedal and is connected to the drive train, electric generator or the wheels. The animal cycle is provided with an optional auxiliary engine powered by any of the power sources such as fuel, electric power, and the like. The animal cycle is provided with standard features of a bicycle including lights, gears, brakes and the like

### BRIEF DESCRIPTION OF THE DRAWINGS

The above-mentioned and other features and advantages of this present disclosure, and the manner of attaining them, will become more apparent and the present disclosure will be better understood by reference to the following description of embodiments of the present disclosure taken in conjunction with the accompanying drawings, wherein:

FIG. 1 is a diagram depicting a perspective view of an animal cart.

FIG. 2 is a diagram depicting a perspective view of a wheeled animal powered vehicle.

FIG. 3 is a diagram depicting a perspective view of an animal cycle.

### DETAILED DESCRIPTION OF THE INVENTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

Exemplary embodiments of the present invention are directed towards a system for conversion of an animal muscle power to a mechanical or electrical energy. According to a non limiting exemplary a first aspect of the present invention, a system for conversion of animal muscle power to electrical or mechanical energy includes a animal cart which includes a chassis to accommodate at least one of an animal at a predetermined position, at least one first crank set to accommodate the front legs, at least one second crank set to accommodate the hind legs, at least one third crank set is provided for the rider and at least one axle for enabling the conversion of the animal muscle power to driving force. The crank set may comprise a pedal, a sprocket, a pulley, a chain, a driving belt or similar mechanisms to convert the natural movement of the feet to mechanical or electrical energy.

According to a non limiting exemplary the first aspect of the present invention, the system for conversion of an animal muscle power to an electrical or mechanical energy includes at least one set of pedals and at least one crank set to accommodate the front legs, and/or at least one set of pedals to accommodate the hind legs of at least one animal. The animal cart is accommodated with the at least one of the animal, which operates the vehicle by placing at least one foot in or on the pedals of the animals cart. The animal operates by pressing the pedals in the forward or backward direction, which is converted to either mechanical or electrical energy. The conversion of muscle power to electrical energy is achieved by an energy conversion device associated with the pedals and crank set or the like. The electrical energy generated is used either directly or stored in a storage device (e.g. like a rechargeable battery) and used to drive the animal powered vehicle using an electric motor located on the axel of the wheel(s).

According to a non limiting exemplary the first aspect of the present invention, the system for conversion of an animal muscle power to an electrical or mechanical energy includes, the pedals of the crank set positioned to accommodate the front legs and/or rear legs of the animal can be pedaled in either of a clock wise direction or an anti clock wise direction according to the anatomy of the front or rear legs of the animal. Alternatively, the animal cart can be provided with a tread mill type of mechanism, instead of the pedaling system to convert muscle power to a mechanical or electrical energy. The tread mill type system comprises of rollers and a moving sheet of belt of other provisions, and allows the animal to walk naturally on the rolling sheet, while remaining stable at in one place. The walking movement of the animal results in rotational movement of the rollers, which in turn is used to drive the animal cart.

According to a non limiting exemplary the first aspect of the present invention, the system for conversion of an animal muscle power to an electrical or mechanical energy includes at least one transmission element can be positioned between the crank set and a drive train to integrate the crank set to the drive train for transferring the energy of the crank set to the drive train and or the wheels. A drive train extending between a plurality of wheels and the at least one of the transmission element facilitates the transmitting of the driving force to the axle with associated gear mechanism, causing the animal cart to move.

According to a non limiting exemplary the first aspect of the present invention, the system for conversion of an animal muscle power to an electrical or mechanical energy includes at least one additional crank set for at least one rider (or driver) of the animal cart at a predetermined position to convert human pedaling power to driving power. The driving force from the at least such one additional crank set provided to the rider is integrated by the transmission element into the drive train in a similar fashion, as described earlier in previous paragraph.

According to a non limiting exemplary the first aspect of the present invention, the system for conversion of an animal muscle power to an electrical or mechanical energy includes the animal cart provided with a steering mechanism, braking system, that may including additional features such as the ability to capture breaking energy when stopped (regenerative breaking energy type), manual or an automated gear mechanism, accelerator, clutch, suspension systems and shock absorbers to cushion the ride, differential systems to improve stability, power supply, lights, signals, horn, fans, air conditioning, auxiliary power sources, hitches for trailers or auxiliary equipment, devices to connect and power the auxiliary equipment, and the like. The front, sides, back, and top of the animal cart are covered appropriately to provide protection to the animal and rider from the sun, wind, snow and the rain or other weather conditions, and road hazards, and for improved visibility.

According to a non limiting exemplary the first aspect of the present invention, the system for conversion of an animal muscle power to an electrical or mechanical energy includes the plurality of pedals provided for the animal are accommodated with an anti-slippery top surface, and provisions to securely hold at least one of an animal hoof or foot to the plurality of pedals, thereby allowing for free movement of the feet, while pedaling. The shape of the pedals can be flat, cup shaped, tubular, a long grove and provided with straps, belts, bolts, clip on mechanism or provided with magnets or similar devices to facilitate the animal to engage and disengage the pedals with its hooves easily, while allowing for free movement of the legs. Further, the shape, size and position of the crank sets and pedals on the chassis and the weight bearing mechanism (described below), holding devices, distance between the wheels, chassis shape and strength, and other devices on the animal cart can be changed or adjusted to accommodate different type, size, shape and weight animals so as to maintain the functionality of the animal cart.

According to a non limiting exemplary the first aspect of the present invention, the system for conversion of an animal muscle power to an electrical or mechanical energy includes at least one of a weight bearing provision located on the animal cart at a predetermined position to partially or completely bear the weight of the animal. The weight bearing provision can be positioned to come into contact with ventral, lateral, dorsal, posterior or anterior aspects of the body at any location, including head, neck, legs, shoulder, sternum, chest, abdomen, pelvic, rump, thigh, and hip regions of the body so as to bear most of the weight of the upper body of the animal (the part of the animal excluding limbs), thereby, minimizing the weight on the feet. The weight bearing provision functions very similar to a standard bicycle seat, which supports the majority of the weight of the upper body of the human rider, excluding the feet. The weight bearing provision can be a suspension type (e.g., similar to hammock) or a standard seat type positioned appropriately to bear the weight of the animal. The height of the weight bearing provision relative to the pedals or the like devices is adjusted such that the significant portion of the weight of the animal including head, neck and torso or the trunk portion of the animal are shifted to the weight bearing provision from its feet, when positioned on the animal cart. The weight bearing mechanism thereby allows the animal to use its leg muscles to rotate the pedals, without lifting itself against the gravity when pedaling, there by maximizing the efficiency with which the muscle power is converted to mechanical or electrical energy for sustained driving of the animal cart, without undue physiological stress. The animal cart is provided with mechanisms to adjust the height of the device, so that weight of the animal can be completely switched to its feet, and in turn on to pedals when necessary, so that animal can use its weight to aid in pedaling, when higher input is required over short periods. The weight bearing mechanism could be a plurality of devices, and can be supported from bottom, on the sides, top or in the front and back. The weight bearing provision can be anchored to the chassis, suspended from top, supported from bottom or sides or attached to any other part of the animal cart, and its weight can be raised or lowered and its position relative to other parts of the vehicle are adjusted using either a suspension type of system or using manual or automated adjustment systems (e.g. a hydraulic telescoping type). The shape and size of the weight bearing provision can be modified to fit individual animals of different species, size, shape, weight, anatomical structures or the like. The additional devices made of or lined with appropriate material to support the animal while pedaling, while quick release of animal and at emergency situations.

According to a non limiting exemplary the first aspect of the present invention, the system for conversion of an animal muscle power to an electrical or mechanical energy includes the animal cart provided with a movable ramp used by the animals to climb onto a raised platform where the pedals and the weight bearing mechanism are arranged. Alternatively, an optional, lifting mechanism is provided to lift the animal to a predetermined height and to securely position in the weight bearing provision. The mechanism is adjusted either manually, or powered by either the animal, human or by other alternative means (e.g., an electric battery or fuel-powered auxiliary mechanism on board). To minimize impact to the weight bearing portions of the animals when secured to the weight bearing provision, the weight bearing mechanism is secured using plurality of suspension systems, springs, control arms, shock absorbers, mechanical dampers and the like.

According to a non limiting exemplary the first aspect of the present invention, the system for conversion of an animal muscle power to an electrical or mechanical energy includes at least one collar, at least one harness, and at least one restraint is provided for securing at least one animal positioned over the weight bearing provision. The animal cart comprises of other mechanisms secured to the head or various parts of the body to facilitate communication of driver/rider's intention to the animal so as to make the animal perform certain actions. The animal cart further comprises of an additional safety mechanisms like air bags are provided to protect the animals in a collision and quick-release mechanism in emergency situations. The animal cart will be equipped with appropriate sensors and mechanisms that sense the potential changes in the balance of the animal cart due to movement of the animal and those than can institute the appropriate corrective mechanisms to maintain the balance. Further, the animal cart is provided with appropriate sensors and mechanisms to measure and display certain parameters such as body temperature, heart rate, respiratory rate and the like to monitor the physiological status of the animal.

According to a non limiting exemplary the first aspect of the present invention, the system for conversion of an animal muscle power to an animal muscle power to an electrical or mechanical energy includes the provisions to provide food, water and other required. Additionally, the animal cart is equipped with additional mechanisms positioned appropriately at external orifices to collect external discharges such as urine and feces from the animal for secure storage and disposal. Further, appropriate mechanisms such as covers, shields, etc are provided to protect the various parts of the animal cart and the rider/driver from the animal discharges. The animal cart includes at least one provision to release the securely held feet of the animal from the plurality of pedals, as well as to release the animal from the weight bearing mechanism and the restraints.

According to a non limiting exemplary a second aspect of the present invention, a system for conversion of an animal muscle power to an electrical or mechanical energy comprises a wheeled animal powered vehicle includes a chassis to accommodate at least one of an animal at a predetermined position, at least one first crank set to accommodate the front legs, at least one second crank set to accommodate the hind legs, at least one additional crank set is provided for the rider and at least one axle for enabling the conversion of the animal muscle power to driving force. The crank set may comprise a pedal, a sprocket, a pulley, a chain, a driving belt or similar mechanisms to convert the natural movement of the feet to mechanical or electrical energy.

According to a non limiting exemplary the second aspect of the present invention, the system for conversion of an animal muscle power to an electrical or mechanical energy includes at least one set of pedals and at least one crank set to accommodate the front legs, and/or at least one set of pedals to accommodate the hind legs of at least one animal. The wheeled animal powered vehicle is accommodated with the at least one of the animal, which operates the vehicle by placing at least one foot in or on the pedals. The animal operates by pressing the pedals in the forward or backward direction, which is converted to either mechanical or electrical energy. The conversion of muscle power to electrical energy is achieved by an energy conversion device associated with the pedals and crank set or the like. The electrical energy generated is used either directly or stored in a storage device (e.g. like a rechargeable battery) and used to drive the animal powered vehicle using an electric motor located on the axel of the wheel(s).

According to a non limiting exemplary the second aspect of the present invention, the system for conversion of an animal muscle power to an electrical or mechanical energy includes the pedals of the crank set positioned to accommodate the front legs and/rear legs of the animal can be pedaled in either of a clock wise direction or an anti clock wise direction according to the anatomy of the front or rear legs of the animal. Alternatively, the wheeled animal powered vehicle can be provided with a tread mill type of mechanism, instead of the pedaling system to convert muscle power to a mechanical or electrical energy. The tread mill type system comprises of rollers and a moving sheet of belt of other provisions, and allows the animal to walk naturally on the rolling sheet, while remaining stable at in one place. The walking movement of the animal results in rotational movement of the rollers, which in turn is used to drive the animal cart.

According to a non limiting exemplary the second aspect of the present invention, the system for conversion of an animal muscle power to an electrical or mechanical energy comprises at least one transmission element can be positioned between the crank set and a drive train to integrate the crank set to the drive train for transferring the rotational energy of the crank set to the drive train and or the wheels. A drive train extending between a plurality of wheels and the at least one of the transmission element facilitates the transmitting of the driving force to the axle with associated gear mechanism, causing the wheeled animal powered vehicle to move.

According to a non limiting exemplary the second aspect of the present invention, the system for conversion of an animal muscle power to an electrical or mechanical energy includes at least one additional crank set is provided for the rider (or driver) of the wheeled animal powered vehicle at a predetermined position to convert human pedaling power to driving power. The driving force from the at least one additional crank set provided to the rider is integrated by the transmission element into the drive train in a similar fashion, as described earlier in previous paragraph.

According to a non limiting exemplary the second aspect of the present invention, the system for conversion of an animal muscle power to an electrical or mechanical energy includes an electrical energy generator is provided along with the crank sets that may be associated with the pedals, the crank, the pulley or the within the crank set provided for each animal and the rider to convert the peddling power of both the rider and/or the animal in to an electrical energy and which is further stored in at least one of a rechargeable battery unit. An electrical power output socket with a phase shifting/converter mechanism is provided to convert the electrical energy generated from the at least one of the electrical generator at a pre determined efficiency ratio and is further transferred through a cable and stored in at least one of the rechargeable batteries.

According to a non limiting exemplary the second aspect of the present invention, the system for conversion of an animal muscle power to an electrical or mechanical energy includes an at least one auxiliary power generation unit such as fuel engine, electric engine, a hybrid engine and the like to improve the speed of the vehicle by utilizing the electrical energy stored in the rechargeable batteries to move along or to make a at least one of a wheeled vehicle coupled at a pre determined position to the animal powered vehicle to move or make them work. The at least one of the wheeled vehicle coupled to the animal powered vehicle could be a trolley or the like that could be used to transport goods or the like and/or to cultivate or the like.

According to a non limiting exemplary the second aspect of the present invention, the system for conversion of an animal muscle power to an electrical or mechanical energy comprises the wheeled animal powered vehicle provided with a steering mechanism, braking system, that may including additional features such as the ability to capture breaking energy when stopped (regenerative breaking energy type), manual or an automated gear mechanism, accelerator, clutch, suspension systems and shock absorbers to cushion the ride, differential systems to improve stability, power supply, lights, signals, horn, fans, air conditioning, auxiliary power sources, hitches for trailers or auxiliary equipment, devices to connect and power the auxiliary equipment, and the like. The front, sides, back, and top of the animal cart are covered appropriately to provide protection to the animal and rider from the sun, wind, snow and the rain or other weather conditions, and road hazards, and for improved visibility.

According to a non limiting exemplary the second aspect of the present invention, the system for conversion of an animal muscle power to an electrical or mechanical energy includes the plurality of pedals provided for the animal are accommodated with an anti-slippery top surface, provisions to securely hold at least one of an animal hoof or foot to the plurality of pedals, thereby allowing for free movement of the feet, while pedaling. The shape of the pedals can be flat, cup shaped, tubular, a long grove and provided with straps, belts, bolts, clip on mechanism or provided with magnets or similar devices to facilitate the animal to engage and disengage the pedals with its hooves easily, while allowing for free movement of the legs. Further, the shape, size and position of the crank sets and pedals and the like, on the chassis and weight bearing mechanism, holding devices, distance between the wheels, chassis shape and strength, and other devices on the wheeled animal powered vehicle can be changed or adjusted to accommodate different type, size, shape and weight animals so as to maintain the functionality of the wheeled animal powered vehicle.

According to a non limiting exemplary the second aspect of the present invention, the system for conversion of an animal muscle power to an electrical or mechanical energy includes at least one of a weight bearing provision at a predetermined position to partially or completely bear the weight of the animal. The weight bearing provision can be positioned to come into contact with ventral, lateral, dorsal, posterior or anterior aspects of the body at any location, including head, neck, legs, shoulder, sternum, chest, abdomen, pelvic, rump, thigh, and hip regions of the body so as to bear most of the weight of the upper body of the animal (the part of the animal excluding limbs), thereby, minimizing the weight on the feet. The weight bearing provision functions very similar to a standard bicycle seat, which supports the majority of the weight of the upper body of the human rider, excluding the feet. The weight bearing provision can be a suspension type (e.g., similar to hammock) or a standard seat type positioned appropriately to bear the weight of the animal. The height of the weight bearing provision relative to the pedals or the like devices is adjusted such that the significant portion of the weight of the animal including head, neck and torso or the trunk portion of the animal are shifted to the weight bearing provision from its feet, when positioned on the animal cart. The weight bearing mechanism thereby allows the animal to use its leg muscles to rotate the pedals, without lifting itself against the gravity when pedaling, there by maximizing the efficiency with which the muscle power is converted to mechanical or electrical energy for sustained driving of the wheeled animal powered vehicle, without undue physiological stress. The animal powered wheeled vehicle is provided with mechanisms to adjust the height of the device, so that weight of the animal can be completely switched to its feet, and in turn on to pedals when necessary, so that animal can use its weight to aid in pedaling, when higher input is required over short periods. The weight bearing mechanism could be a plurality of devices, and can be supported from bottom, on the sides, top or in the front and back. The weight bearing provision can be anchored to the chassis, suspended from top, supported from bottom or sides or attached to any other part of the vehicle, and its weight can be raised or lowered and its position relative to other parts of the vehicle are adjusted using either a suspension type of system or using manual or automated adjustment systems (e.g. a hydraulic telescoping type). The shape and size of the weight bearing provision can be modified to fit individual animals of different species, size, shape, weight, anatomical structures or the like., The additional devices made of or lined with appropriate material to support the animal while pedaling, while quick release of animal and at emergency situations.

According to a non limiting exemplary the second aspect of the present invention, the system for conversion of an animal muscle power to an electrical or mechanical energy includes the wheeled animal powered vehicle provided with a movable ramp used by the animals to climb onto a raised platform where the pedals and the weight bearing mechanism are arranged. Alternatively, an optional, lifting mechanism is provided to lift the animal to a predetermined height and to securely position in the weight bearing provision. The mechanism is adjusted either manually, or powered by the either animal, human or by other alternative means (e.g., an electric battery or fuel-powered auxiliary mechanism on board). To minimize impact to the weight bearing portions of the animals when secured to the weight bearing provision, the weight bearing mechanism is secured using plurality of suspension systems, springs, control arms, shock absorbers, mechanical dampers and the like.

According to a non limiting exemplary the second aspect of the present invention, the system for conversion of an animal muscle power to an electrical or mechanical energy includes at least one collar, at least one harness, and at least one restraint is provided for securing at least one animal positioned over the weight bearing provision. The wheeled animal powered vehicle comprises of other mechanisms secured to the head or various parts of the body to facilitate communication of driver/rider's intention to the animal so as to make the animal perform certain actions. The wheeled animal powered vehicle further comprises of an additional safety mechanisms like air bags are provided to protect the animals in a collision and quick-release mechanism in emergency situations. The wheeled animal powered vehicle will be equipped with appropriate sensors and mechanisms that sense the potential changes in the balance of the wheeled animal powered vehicle due to movement of the animal and those than can institute the appropriate corrective mechanisms to maintain the balance. Further, the wheeled animal powered vehicle is provided with appropriate sensors and mechanisms to measure and display certain parameters such as body temperature, heart rate, respiratory rate and the like to monitor the physiological status of the animal.

According to a non limiting exemplary the second aspect of the present invention, the system for conversion of an animal muscle power to an electrical or mechanical energy includes the provisions to provide food, water and other required. Additionally, the wheeled animal powered vehicle is equipped with additional mechanisms positioned appropriately at external orifices to collect external discharges such as urine and feces from the animal for secure storage and disposal. Further, appropriate mechanisms such as covers, shields, etc are provided to protect the various parts of the animal cart and the rider/driver from the animal discharges. The wheeled animal powered vehicle includes at least one provision to release the securely held feet of the animal from the plurality of pedals, as well as to release the animal from the weight bearing mechanism and the restraints.

According to a non-limiting exemplary a third aspect of the present invention, the system for conversion of an animal muscle power to an electrical or mechanical energy includes an animal cycle with at least two wheels, a front and a rear wheel (e.g., like a bicycle). Additional wheels may be provided to maintain the balance of the animal cycle. The chassis or the frame of the animal cycle is provided with at least one crank set to convert the animal muscle power to mechanical or electrical energy, and provisions for steering (e g handle), breaking, gear shifting, lighting mechanisms.

According to a non limiting exemplary the third aspect of the present invention, the system for conversion of an animal muscle power to an electrical or mechanical energy includes a chassis to accommodate at least one of an animal at a predetermined position, at least one first crank set to accommodate the front legs, at least one second crank set to accommodate the hind legs, at least one third crank set is provided for the rider and at least one axle for enabling the conversion of the animal muscle power to driving power. The crank set may comprise a pedal, a sprocket, a pulley a chain a driving belt and the like. Additionally, the animal cycle comprises of a weight bearing provision to bear the weight of most of the animal in order to minimize its weight on the feet, there by facilitating the pedaling, without the animal lifting itself against gravity, to maximize the efficiency.

According to a non limiting exemplary the third aspect of the present invention, the system for conversion of an animal muscle power to an electrical or mechanical energy includes the animal cycle provided with at least one gyroscopic mechanism to maintain the balance of the vehicle when at rest or while in motion. The rider is provisioned to be seated on the top of the animal, or alternatively on a seat attached to the chassis or other parts, and positioned either above on the sides, back or in front of the animal. The animal cycle is provided with at least one optional crank set to pedal and is connected to the drive train, electric generator or the wheels. The animal cycle is provided with an optional auxiliary engine powered by any of the power sources such as fuel, electric power, and the like. The animal cycle is provided with standard features of a bicycle including lights, gears, brakes and the like.

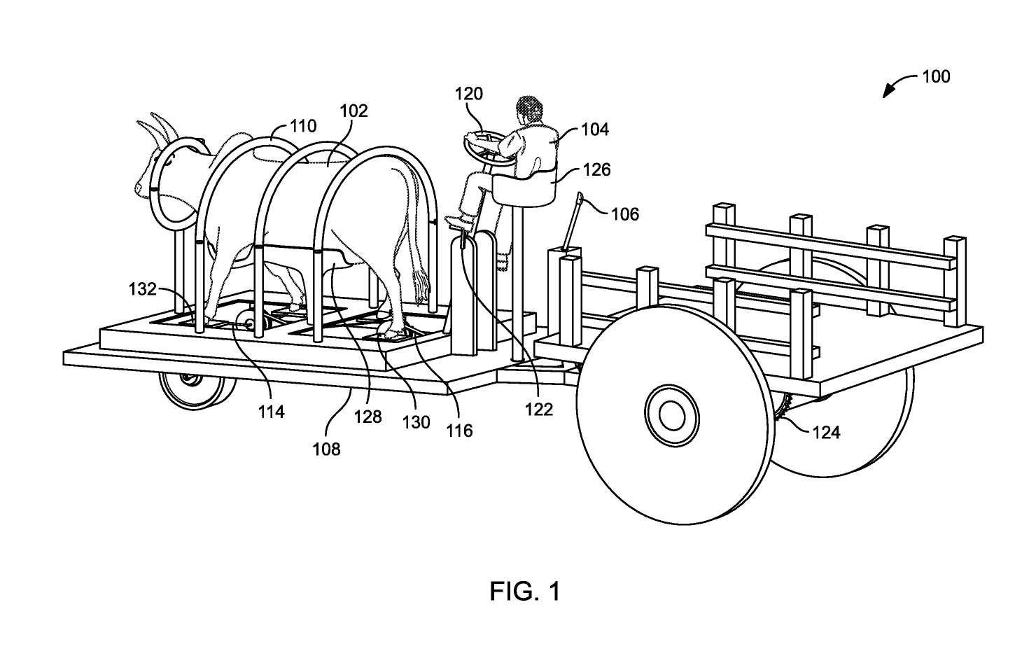

Referring to FIG. 1 is a diagram 100 depicting a perspective view of an animal cart. According to a non limiting exemplary embodiment of the present invention, the animal cart 100 includes a chassis 108 to accommodate at least one of an animal 102 at a predetermined position, at least one first crank set 114 to accommodate the front legs, at least one second crank set 116 to accommodate the hind legs, at least one third crank set 122 is provided for the rider 104 and at least one axle 124 for enabling the conversion of the animal muscle power to driving power. The crank set may comprise a pedal, a sprocket, a pulley a chain a driving belt and the like.

In accordance to a non limiting exemplary embodiment of the present invention, the pedal 132 at the front portion and the rear portion 130 of the animal cart 100 is accommodated with the at least one of the animal 102 by placing its foot on to the pedals of the crank set. The pedaling of the animal 102 generates the driving power. The pedaling power of the animal 102 is converted to the electrical power by means of an energy conversion device. The pedals of the crank set positioned at the front portion and the rear portion of the animal cart 100 can be pedaled in either of a clock wise direction or an anti clock wise direction according to the anatomy of the animal 102.

According to a non limiting exemplary embodiment of the present invention, the animal cart 100 includes at least one transmission element can be positioned between the crank set and a drive train to integrate the crank set to the drive train for transferring the rotational energy of the crank set. A drive train extending between a plurality of wheels and the at least one of the transmission element facilitates the transmitting of the driving force to the axle with associated gear mechanism, causing the animal cart to move. The driving force from the at least one third crank set 122 provided to the rider 104 is integrated by the transmission element in a similar fashion.

In accordance to a non limiting exemplary embodiment of the present invention, the animal cart 100 is provided with a steering mechanism 120 (handle or a steering wheel), braking system 106 (standard or regenerative energy type), manual or an automated gear mechanism, accelerator, clutch, power supply, lights and the like. The plurality of pedals provided for the animal 102 are accommodated with an anti-slippery top surface, provisions to securely hold at least one of an animal foot to the plurality of pedals, thereby allowing for free movement of the feet. Further, the shape, size and position of the crank sets and pedals on the chassis and weight bearing mechanism, holding devices in the animal cart can be changed or moved around to accommodate different size animals and the driving conditions. The front, sides, back, and top of the animal cart are covered with at least one of the glass, fabric and the like materials appropriately, to provide protection to the animal and rider from road hazards and changing weather and for visibility.

According to a non limiting exemplary embodiment of the present invention, the animal cart 100 includes at least one of a weight bearing provision 128 at a predetermined position to partially or completely bear the weight of the at any location including but not limited to neck, shoulder, sternum, chest, abdomen, pelvic and hip, regions of the body to minimize the weight on the foot. Further, the weight bearing provision 128 allows the animal 102 to use its leg muscles to pedal, without lifting itself against the gravity when pedaling, there by maximizing the efficiency. The weight bearing provision 128 can be provided to have at least one of a base, a side, can be adjusted appropriately support the weight of the animals of different types, shapes and weight. The weight bearing provision can be a suspension type (e.g. like a hammock) or can be of a standard seat type, supported from any direction.

In accordance to a non limiting exemplary embodiment of the present invention, the animal cart 100 provided with a movable ramp used by the animals to climb onto a raised platform where the pedals and the weight bearing mechanism are arranged. Alternatively, an optional, lifting mechanism is provided to lift the animal to a predetermined height and to securely position in the weight bearing provision 128. The mechanism is either powered by the animal, human or by other alternative means (e.g., an electric battery or fuel-powered auxiliary mechanism on board). The weight bearing mechanism can be of a suspension type and a hydraulic type or the like. The suspension system supported on a base including at least one of control arms, springs, shock absorbers, mechanical dampers and the like. The rider 104 is provisioned with a seat 126, but not directly bearing weight on the animal or alternatively on a seat attached to the chassis or other parts, and positioned either above on the sides, back or in front of the animal 102.

According to a non limiting exemplary embodiment of the present invention, the animal cart 100 includes provisions 110 for securely hold the animal. The provisions 110 are attached while placing the animal in the predetermined position. At least one collar, harness, and restraints are provided for soft and secure holding of the animal 102 positioned over the weight bearing provision. The animal cart 100 comprises of other provisions or other alternate means secured to the head or various parts of the body to make the animal 102 perform certain actions. The animal cart 100 further comprises of an additional safety mechanisms like air bags are provided to protect the animals in a collision and quick-release mechanism in emergency situations. Further, the animal cart 100 is provided with appropriate sensors to measure the physiological parameters such as heart rate, respiratory rate and the like to monitor the physiological status of each animal 102.

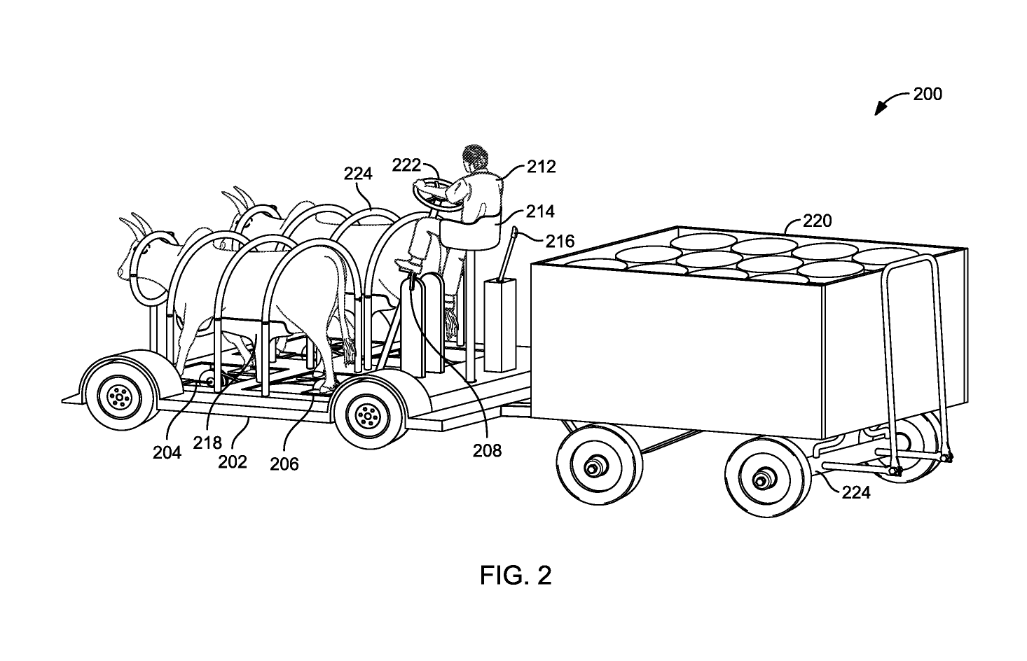

Referring to FIG. 2 is a diagram 200 depicting a perspective view of a wheeled animal powered vehicle. According to a non limiting exemplary embodiment of the present invention, a wheeled animal powered vehicle 200 includes a chassis 202 to accommodate at least one of an animal at a predetermined position, at least one first crank set to accommodate the front legs 204, at least one second crank set 206 to accommodate the hind legs, at least one third crank set 208 is provided for the rider 212 and at least one axle 224 for enabling the conversion of the animal muscle power to driving power. The crank set may comprise a pedal, a sprocket, a pulley, a chain a driving belt and the like.

In accordance to a non limiting exemplary embodiment of the present invention, the pedal at the front portion and the rear portion of the wheeled animal powered vehicle 200 is accommodated with the at least one of the animal by placing its foot on to the pedals of the crank set. The pedaling of the animal generates the driving power. The pedaling power of the animal is converted to the electrical power by means of an energy conversion device. The pedals of the crank set positioned at the front portion and the rear portion of the wheeled animal powered vehicle 200 can be pedaled in either of a clock wise direction or an anti clock wise direction according to the anatomy of the animal.

According to a non limiting exemplary embodiment of the present invention, the wheeled animal powered vehicle 200 at least one transmission element can be positioned between the crank set and a drive train to integrate the crank set to the drive train for transferring the rotational energy of the crank set. A drive train extending between a plurality of wheels and the at least one of the transmission element facilitates the transmitting of the driving force to the axle with associated gear mechanism, causing the wheeled animal powered vehicle 200 to move. The driving force from at least one third crank set 208 provided to the rider 212 is integrated by the transmission element in a similar fashion.

In accordance to a non limiting exemplary embodiment of the present invention, an electrical energy generator is provided along with the crank sets that may be associated with the pedals, the crank, the pulley or the within the crank set provided for each animal and the rider 212 to convert the peddling power of both the rider 212 and/or the animal in to an electrical energy and which is further stored in at least one of a rechargeable battery unit. An electrical power output socket with a phase shifting/converter mechanism is provided to convert the electrical energy generated from the at least one of the electrical generator at a pre determined efficiency ratio and is further transferred through a cable and stored in at least one of the rechargeable batteries accommodated in the wheeled animal powered vehicle 200.

According to a non limiting exemplary embodiment of the present invention, the wheeled animal powered vehicle 200 includes at least one auxiliary power generation unit such as fuel engine, electric engine, a hybrid engine and the like to improve the speed of the vehicle by utilizing the electrical energy stored in the rechargeable batteries to move along or to make a at least one of a wheeled vehicle coupled at a pre determined position to the animal powered vehicle 200 to move or make them work. The at least one of the wheeled animal powered vehicle coupled to a load carrier 220 or the like that could be used to transport goods or the like and/or to cultivate or the like.

In accordance to a non limiting exemplary embodiment of the present invention, the wheeled animal powered vehicle is provided with a steering mechanism 222 (handle or a steering wheel), braking system 216 (standard or regenerative energy type), manual or an automated gear mechanism, accelerator, clutch, power supply, lights and the like. The front, sides, back, and top of the animal cart are covered with at least one of the glass, fabric appropriately to provide protection to the animal and rider from road hazards and changing weather and for visibility. The plurality of pedals provided for the animal are accommodated with an anti-slippery top surface, provisions to securely hold at least one of an animal foot to the plurality of pedals, thereby allowing for free movement of the feet. Further, the shape, size and position of the crank sets and pedals on the chassis and weight bearing mechanism, holding devices and the like in the wheeled animal powered vehicle 200 can be changed or moved around to accommodate different size animals.

According to a non limiting exemplary embodiment of the present invention, at least one of a weight bearing provision 218 at a predetermined position to partially or completely bear the weight of the animal. The weight bearing provision can come into contact with any location on the body including but not limited to neck, shoulder, sternum, chest, abdomen, pelvic and hip, regions of the body to support the weight, in order to minimize the weight on the feet. Further, the weight bearing mechanism allows the animal to use its leg muscles to pedal, without lifting itself against the gravity when pedaling, there by maximizing the efficiency. The weight bearing provision 218 can be of a suspension type or can be provided to at least one of a base, a side and the weight bearing provision 218 can be a holding provision provided on the top of the animal. The weight bearing mechanism can be raised or lowered using either a suspension type of system from the top or and using a hydraulic telescoping type of system or a manual adjustment mechanism, or the like. The shape and size of the weight bearing provision can be modified to fit the animal, accommodate additional devices such as devices to collect excretions from the animal, or made of or lined with appropriate cushioning material to minimize any potential discomfort to the animal while pedaling or during rest.

In accordance to a non limiting exemplary embodiment of the present invention, the wheeled animal powered vehicle 200 provided with a movable ramp used by the animals to climb onto a raised platform where the pedals and the weight bearing mechanism are arranged. Alternatively, an optional, lifting mechanism is provided to lift the animal to a predetermined height and to securely position in the weight bearing provision 218. The mechanism is either powered by the animal, human or by other alternative means (e.g., an electric battery or fuel-powered auxiliary mechanism on board). The weight bearing mechanism can be of a suspension type and a hydraulic type or the like. The suspension system supported on a base including at least one of control arms, springs, shock absorbers, mechanical dampeners and the like.

According to a non limiting exemplary embodiment of the present invention, the wheeled animal powered vehicle 200 includes provisions 224 for securely holding the animals. The detachable provisions 224 are attached while placing the animal in the predetermined position. At least one collar, harness, and restraints are provided for soft and secure holding of the animals positioned over the weight bearing provision. The wheeled animal powered vehicle 200 comprises of other mechanisms secured to the head or various parts of the body to facilitate communication of driver's intention to the animal so as to make the animal perform certain actions. The wheeled animal powered vehicle 200 further comprises of an additional safety mechanisms like air bags, belts, and the like to protect the animals in a collision and quick-release mechanism in emergency situations. Further, the wheeled animal powered vehicle 200 is provided with appropriate sensors to measure the physiological parameters such as heart rate, respiratory rate and the like to monitor the physiological status of each animal. The rider 212 is provisioned with a seat 214, but not directly bearing weight on the animal or alternatively on a seat attached to the chassis or other parts, and positioned either above on the sides, back or in front of the animals.

In accordance to a non limiting exemplary embodiment of the present invention, the provisions to provide food, drink and containers positioned appropriately to collect excreta of the animal. The wheeled animal powered vehicle 200 includes at least one provision to release the securely held feet of the animal from the plurality of pedals and the animal from the weight bearing mechanism and the surrounding restraints. Alternatively the wheeled animal powered vehicle can be provided with a tread mill instead of the pedaling system to generate the electrical or mechanical power. The tread mill is machine used for walking while staying in one place.

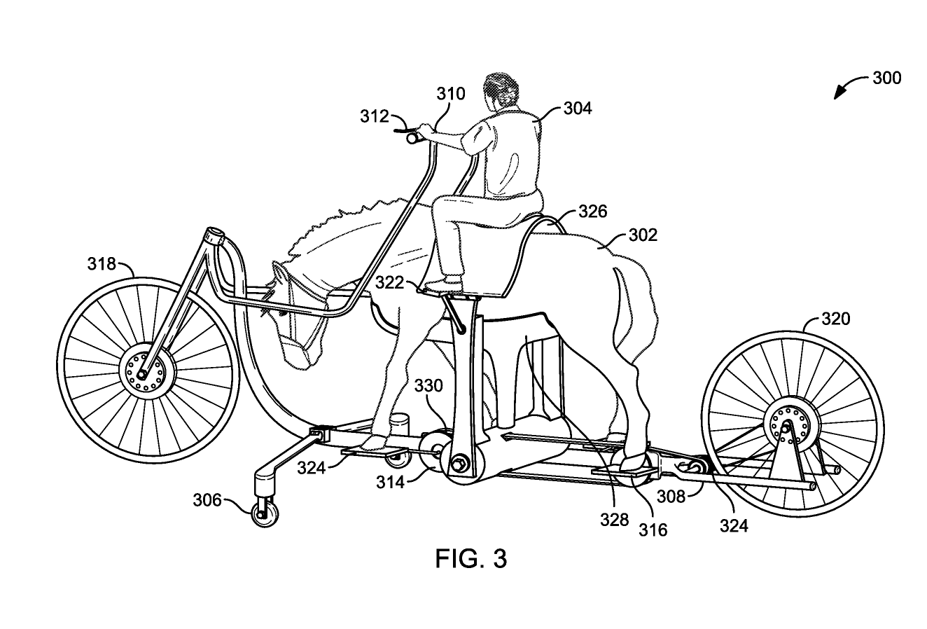

Referring to FIG. 3 is a diagram 300 depicting a perspective view of an animal cycle. According to a non limiting exemplary embodiment of the present invention, the animal cycle 300 includes a chassis 308 to accommodate at least one of an animal 302 at a predetermined position, at least one first crank set 314 to accommodate the front legs, at least one second crank set 316 to accommodate the hind legs, at least one third crank set 322 provided for the rider 304 and at least one axle 324 for enabling the conversion of the animal muscle power to driving power. The crank set may comprise a pedal 324, a sprocket, a pulley, a chain a driving belt and the like.

In accordance to a non limiting exemplary embodiment of the present invention, the animal cycle includes at least two wheels, a front wheel 318 and a rear wheel 320 (e.g., like a bicycle). Additional wheels 306 may be provided to maintain the balance of the animal cycle 300. The animal cycle is provided with standard features of a bicycle including provisions for steering 310 (e.g. handle), braking system 312, gear shifting, lighting mechanisms. At least one transmission element can be positioned between the crank set and a drive train to integrate the crank set to the drive train for transferring the rotational energy of the crank set. A drive train extending between a plurality of wheels and the at least one of the transmission element facilitates the transmitting of the driving force to the axle 324 with associated gear mechanism, causing the animal cycle 300 to move

According to a non limiting exemplary embodiment of the present invention, the animal cycle 300 provided with at least one gyroscopic mechanism to maintain the balance of the vehicle when at rest or while in motion. The rider 304 is provisioned with a seat 326 on the top of the animal, but not directly bearing weight on the animal or alternatively on a seat attached to the chassis or other parts, and positioned either above on the sides, back or in front of the animal 302. The animal cycle 300 is provided with at least one optional crank 322 set to for the use of the rider and is connected to the drive train, electric generator or the wheels. The animal cycle 300 is provided with an optional auxiliary engine powered by any of the power sources such as fuel, electric power, and the like.

In accordance to a non limiting exemplary embodiment of the present invention, the animal positioned in the predetermined position is provided with a weight bearing provision 328 accommodated to support the weight of the animal to facilitate the animal to ride the cycle without bearing its weight. The weight bearing provision 328 can be of a suspension type or supported from the bottom, sides, front or back whose position can be adjusted using manual or automated means. The animal cycle 300 is provided with a movable ramp used by the animals to climb onto a raised platform where the pedals and the weight bearing mechanism are arranged. Alternatively, an optional, lifting mechanism is provided to lift the animal to a predetermined height and to securely position in the weight bearing provision. The mechanism is either powered by the animal, human or by other alternative means (e.g., an electric battery or fuel-powered auxiliary mechanism on board). The provisions to provide food, drink and containers positioned appropriately to collect excreta of the animal

As will be appreciated by a person skilled in the art the present invention provides a variety of advantages. The invention firstly provides animal riding vehicle to make the animal comfortable and stress free thereby resulting an effective transportation. The invention secondly provides an eco friendly vehicle.

While specific embodiments of the invention have been shown and described in detail to illustrate the inventive principles, it will be understood that the invention may be embodied otherwise without departing from such principles.

1. An animal power driven vehicle, comprising:
a chassis mounted over at least one wheel of the animal power driven vehicle;
at least one weight bearing provision coupled to the chassis at a predetermined position to bear a weight of at least one animal, whereby the at least one weight bearing provision enables the at least one animal to pedal by moving its legs without lifting itself against a gravity;
at least one lifting system for lifting and accommodating the at least one animal on the at least one first crank set; and the at least one weight bearing provision, whereby the at least one lifting mechanism powered by at least one of: a manual power; an electric power; a fuel power;
at least one movable ramp to facilitate an easy access of at least one animal to the weight-bearing provision and the at least one first crank set and the at least one second crank set;
at least one first crank set to accommodate front legs of at least one animal to generate and convert a rotational energy of the at least one first crank set to a vehicle driving energy, whereby a pedaling of the at least one first crank set by the at least one animal generates the rotational energy; and
at least one second crank set to accommodate hind legs of the at least one animal to generate and convert the rotational energy of the at least one second crank set to the vehicle driving energy, whereby the pedaling of the at least one second crank set by the at least one animal generates the rotational energy at least one third crank set to accommodate at least one rider to generate and convert the rotational energy of the at least one third crank set to the vehicle driving energy, whereby the pedaling of the at least one third crank set by the at least one rider generates the rotational. energy;
at least one drive transmission element coupled between the at least one first crank set and the at least one second crank set; the at least one second crank set and the at least one third crank set; whereby the at least one drive transmission element configured to transmit the rotational energy of the at least one first crank set; the rotational energy of the at least one second crank set; the rotational energy of the at least one third crank set to at least one drivetrain extending between the at least one wheel and the at least one drive transmission element;
at least one axle coupled between the at least one wheel for converting the rotational energy of the at least one first crank set; the rotational energy of the at least one second crank set; the rotational energy of the at least one third crank set to the vehicle driving energy for enabling a movement of the at least one wheel, whereby the at least one drivetrain enables a transmission of the rotational energy to the at least one axle;
a brake system configured for controlling the movement of the at least one wheel, whereby the brake system coupled to the at least one wheel;
a steering system configured for controlling the direction of the at least one wheel, whereby the steering system coupled to the at least one wheel;
a gear transmission system configured for varying the vehicle driving energy, whereby the gear transmission system coupled to the at least one wheel;
a plurality of detachable provisions coupled to the chassis for securing the at least one animal in a predetermined position;
at least one safety system for protecting the at least one animal in a quick release and emergency situations.
at least one release system for releasing securely held front legs and hind legs of the at least one animal form the at least one first crank set; the at least one second rank set and the at least one weight bearing provision.

2. The vehicle of claim 1, wherein the at least one first crank set; the at least one second crank set; and the at least one third crank set comprising a pair of anti slippery pedals.

3. The vehicle of claim 1, wherein the adjustable weight hearing provision to accommodate different shapes and bear the weight of different sized animals.

4. The vehicle of claim 1, wherein the at least one weight bearing provision comprising at least one of:
a sling-type suspension system hung from the chassis; and
a seat system supported from at least one of a bottom; a side; front; a back; and a top side of the animal.

5. The vehicle of claim 1, Wherein the at least one weight bearing provision to dampen the impact on the at least one animal secured in the vehicle supported by at least one:
a plurality of control arms;
a plurality of springs; and
a plurality of shock absorbers.

6. a plurality of mechanical dampers. The vehicle of claim 1, wherein the at least one seat coupled to the chassis at the predetermined position to accommodate the at least one rider.

7. The vehicle of claim 1, wherein a plurality of sensors provided to measure and monitor physiological parameters of the at least one animal.

8. The vehicle of claim 1, wherein at least one thread mill system mounted on the chassis of the vehicle to accommodate the front and hind legs of the at least one animal for generating the vehicle driving energy.

9. The vehicle of claim 1, wherein the at least one rider initiates the movement of the vehicle by pedaling the at least one third crank set.

10. An animal powered vehicle driven by a plurality of energies formed by a conversion of a rotational energy comprising:
a chassis mounted over at least one wheel of the animal power driven vehicle;
at least one weight bearing provision coupled to the chassis at a predetermined position to bear a weight of at least one animal, whereby the at least one weight bearing provision enables the at least one animal to pedal by moving its legs without lifting itself against a gravity;
at least one lifting system for lifting and accommodating the at least one animal on the at least one first crank set; and the at least one weight bearing provision, whereby the at least one lifting mechanism powered by at least one of: a manual power; an electric power; a fuel power;
at least one movable ramp to facilitate an easy access of at least one animal to the weight-beating provision and the at least one first crank set and the at least one second crank set;
at least one first crank set to accommodate front legs of at least one animal to generate and convert a rotational energy of the at least one first crank set to a vehicle driving energy, whereby a pedaling of the at least one first crank set by the at least one animal generates the rotational energy;
at least one second crank set to accommodate hind legs of the at least one animal to generate and convert the rotational energy of the at least one second crank set to the vehicle driving energy, whereby the pedaling of the at least one second crank set by the at least one animal generates the rotational energy
at least one third crank set to accommodate at least one rider to generate and convert the rotational energy of the at least one third crank set to the vehicle driving energy, whereby the pedaling of the at least one third crank set by the at least one rider generates the rotational energy;
at least one drive transmission element coupled between the at least one first crank set and the at least one second crank set; the at least one second crank set and the at least one third crank set; whereby the at least one drive transmission element configured to transmit the rotational energy of the at least one first crank set; the rotational energy of the at least one second crank set; the rotational energy of the at least one third crank set to at least one drivetrain extending between the at least one wheel and the at least one drive transmission element;
at least one axle coupled between the at least one wheel for converting the rotational energy of the at least one first crank set; the rotational energy of the at least one second crank set; the rotational energy of the at least one third crank set to the vehicle driving energy for enabling a movement of the at least one wheel, whereby the at least one drivetrain enables a transmission of the rotational energy to the at least one axle;
at least one energy conversion system coupled to the at least one first crank set; the at least one second crank set; the at least one third crank set for converting the rotational energy of the at least one first crank set; the rotational energy of the at least one second crank set; the rotational energy of the at least one third crank set to an electrical energy;
at least one energy storing system for storing the electrical energy;
at least one auxiliary power generation system for enhancing the movement of the at least one wheel by utilizing the electrical energy stored in the at least one energy storing system.
a brake system configured for controlling the movement of the at least one wheel, whereby the brake system coupled to the at least one wheel;
a steering system configured for controlling the direction of the at least one wheel, whereby the steering system coupled to the at least one wheel;
a gear transmission system configured for varying the vehicle driving energy, whereby the gear transmission system coupled to the at least one wheel;
a plurality of detachable provisions coupled to the chassis for securing the at least one animal in a predetermined position;
at least one safety system for protecting the at least one animal in a quick release and emergency situations.
at least one release system for releasing securely held front legs and hind, legs of the at least one animal form the at least one first crank set; the at least one second rank set and the at least one weight bearing provision.

11. The vehicle of claim 10, wherein the drive train coupled to the at least one of a motor; and an electrical generator.

12. The vehicle of claim 10, wherein at least one of a load carrier; and a plough device coupled to the chassis and enabled to move by the vehicle driving energy and the electrical energy.

13. The vehicle of claim 10. wherein the at least one rider initiates the movement of the vehicle by pedaling the at least one third crank set.

14. The vehicle of claim 10, wherein the auxiliary power generation system initiates the movement of the vehicle.

15. An animal power driven cycle utilized for recreational purposes comprising:
a chassis mounted over at least one wheel of the animal power driven vehicle;
at least one weight bearing provision coupled to the chassis at a predetermined position to bear a weight of at least one animal, whereby the at least one weight bearing provision enables the at least one animal to pedal by moving its legs without lifting itself against a gravity;
at least one lifting system for lifting and accommodating the at least one animal on the at least one first crank set; and the at least one weight bearing provision, whereby the at least one lifting mechanism powered by at least one of: a manual power; an electric power; a fuel power;
at least one movable ramp to facilitate an easy access of at least one animal to the weight-bearing provision and the at least one first crank set and the at least one second crank set;
at least one first crank set to accommodate front legs of at least one animal to generate and convert a rotational energy of the at least one first crank set to a vehicle driving energy, whereby a pedaling of the at least one first crank set by the at least one animal generates the rotational energy;
at least one second crank set to accommodate hind legs of the at least one animal to generate and convert the rotational energy of the at least one second crank set to the vehicle driving energy, whereby the pedaling of the at least one second crank set by the at least one animal generates the rotational energy
at least one third crank set to accommodate at least one rider to generate and convert the rotational energy of the at least one third crank set to the vehicle driving energy, whereby the pedaling of the at least one third crank set by the at least one rider generates the rotational energy;
at least one drive transmission element coupled between the at least one first crank set and the at least one second crank set; the at least one second crank set and the at least one third crank set; whereby the at least one drive transmission element configured to transmit the rotational energy of the at least one first crank set; the rotational energy of the at least one second crank set; the rotational energy of the at least one third crank set to at least one drivetrain extending between the at least one wheel and the at least one drive transmission element;
at least one axle coupled between the at least one wheel for converting the rotational energy of the at least one first crank set; the rotational energy of the at least one second crank set; the rotational energy of the at least one third crank set to the vehicle driving energy for enabling a movement of the at least one wheel, whereby the at least one drivetrain enables a transmission of the rotational energy to the at least one axle;
at least one handle system provided to at least one rider for controlling the direction of the at least one wheel, whereby the at least one handle system further facilitates the at least one rider maintain the balance of the cycle;
a brake system provided to the at least one handle system for controlling the movement of the at least one wheel, whereby the brake system coupled to the at least one wheel;
a gear transmission system configured for varying the vehicle driving energy, whereby the gear transmission system coupled to the at least one wheel;
a plurality of detachable provisions coupled to the chassis for securing the at least one animal in a predetermined position;
at least one safety system for protecting the at least one animal in a quick release and emergency situations.
at least one release system for releasing securely held front legs and hind legs of the at least one animal form the at least one first crank set; the at least one second rank set and the at least one weight bearing provision.
at least two supporting wheels to maintain balance of the cycle, whereby the at least two supporting wheels adjusted to contact ground for maintaining the balance of the cycle in a stationary motion.

16. The cycle of claim 15, wherein the at least one gyroscopic system maintains the balance of the at least one animal and the at least one rider at a resting state and a moving state.

17. The cycle of claim 15, wherein a provision coupled to the chassis for enabling at least one animal comprising dog to exercise by pedaling.

18. The cycle of claim 17, wherein the provision comprising at least one of:
at least one fourth crank set for accommodating front legs of the at least one animal;
at least one fifth crank set for accommodating hind legs of the at least one animal; and
the at least one weight bearing provision to enable the at least one animal to pedal by moving its legs without lifting itself against a gravity.

19. The cycle of claim 12, wherein the at least one rider initiates the movement of the cycle by pedaling the at least one third crank set.

20. The cycle claim 12, wherein the pedaling of the at least one rider enables the at least one animal to pedal for generating the driving energy.
